(19) United States
(12) Patent Application Publication
(10) Pub. No.: US 2009/0228309 A1
(43) Pub. Date: Sep. 10, 2009

(54) Method and system for optimizing business process management using mathematical programming techniques

(76) Inventor: Georges-Henri Moll, Villeneuve-Loubet (FR)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/635,250

(22) Filed: Dec. 5, 2006

(51) Int. Cl. G06Q 10/00

(52) U.S. Cl. 705/7

(57) ABSTRACT

The present invention relates to methods and systems for optimizing business process management using mathematical programming. In one aspect, the invention allows for formulation of a mixed integer program based on a business process model. The business process may be generically defined using the models set forth. This allows many disparate business processes to be modeled as mixed integer programs.

In a second aspect of the invention, a mixed integer program representing a business process model may be used in connection with simulation of the business process to refine resource assignments. After an initial simulation, later simulations may be refined by using a solution of the mixed integer program to generate resource assignment recommendations. The resource assignment recommendations may influence decisions made in the execution. This may allow the execution to reflect possible improvements to the manner in which events or documents in the business process are dispatched.

### CROSS-REFERENCES TO RELATED APPLICATIONS

None

### STATEMENT REGARDING FEDERALLY SPONSORED RESEARCH OR DEVELOPMENT

None

### INCORPORATION-BY-REFERENCE OF MATERIAL SUBMITTED ON A COMPACT DISC

None

### BACKGROUND OF THE INVENTION

1. Field of the Invention

The present invention relates generally to systems and methods for expressing business process management problems as combinatorial optimization problems. More particularly, the present invention relates to systems and methods for finding improved solutions to business process management problems through the use of linear programming or mixed integer programming techniques.

2. Brief Summary of the Invention

Mixed Integer Programming is a versatile, widely used technique for solving a variety of practical optimization problems. Generally, a mixed integer program (“MIP”) is an optimization problem of the form:

minimize f(x)

subject to G(x)=b
l≦x≦u

some or all xⱼ integral,

where x is a vector of variables, l and u are vectors of bounds, f(x) is an objective expression, and G(x)=b is a set of constraint expressions. While the above model has a minimization objective, one of skill will recognize that models may have maximization objectives.

The simplest and most widely used form of MIP model is the Mixed Integer Linear Program (MILP):

minimize c^{T}x

subject to Ax=b
l≦x≦u

some or all xⱼ integral,

where A is an m by n matrix, called the constraint matrix, and c is the linear objective vector. Thus, as one of ordinary skill in the art would recognize, a MILP is a linear program (“LP”) with an integrality restriction on some or all of the variables. Other forms of MIP model include the Mixed Integer Quadratic Program (MIQP), Mixed Integer Quadratically Constrained Program (MIQCP), and Mixed Integer Non Linear Program (MINLP).

While the integrality restriction makes MIPs difficult to solve (both in general terms, and NP-hard in the technical sense), this restriction also makes the mixed-integer modeling paradigm a powerful tool in representing real-world business applications. In many situations, the solution to a MIP can yield a cost or benefit (for example, in dollars or other units) of pursuing a certain course of business. In a situation wherein the MIP solution yields a cost in dollars, the optimal solution might be one wherein the dollar cost is minimized. In a situation wherein the MIP solution yields the number of linear-feet of lumber that can be harvested from a forest, the optimal solution might be a solution wherein the number of linear-feet is maximized.

A field that has apparently been unrelated to MIP so far is Business Process Management.

Business Process Management (“BPM”) involves managing the workflow of information and documents inside a company or across companies. BPM tasks (sometimes called “steps”) are most often performed by human or machine resources (including, e.g. computers). BPM workflow is often depicted as a graph having nodes and arcs. The nodes are most often used to represent tasks or steps to be performed. The arcs are most often paths from one node to another, depicting possible process flows. In a BPM process, for example, a given document or event may be routed differently through human or machine processing depending on the outcome of each step it encounters. In certain instances, the outcome of the step determines the next step in the processing. With other steps, the process will always proceed to a particular following step, regardless of the outcome of the step. With yet other steps, where the ordering of steps is not crucial, the process may proceed to a number of other steps following the step. A standard for the graphical representation of BPM processes, including steps of the type described above, has been defined by the Object Management Group/Business Process Management Initiative. This standard has been published as document dtc/06-02-01, titled “Business Process Modeling Notation Specification,” dated Feb. 6, 2006. (The Figs. of this patent have not been drafted so as to comply with the standard.)

Many BPM users assign a given document or event at a given step to a given resource in a control oriented manner. In control oriented processing, documents are often queued into step-queues. Redirection of these documents to resource-queues (also called “dispatching”) depends only on the state of one or more step-queues at a given moment. Attempting to solve BPM problems through control, rather than planning, is well known. In such attempts, the dispatching algorithm moves events or documents from step-queues to resource queues. This allocation generally depends on the state of all queues, at a given moment. However, the dispatching algorithm generally does not plan for future events when the allocation decision is made.

One functional difference between BPM and purchase planning, production management, or manufacturing is that BPM is applied to documents or information rather than parts or bills of materials. Documents may include electronic documents, paper documents, partial documents, complete documents, electronic data sets, etc. BPM is not limited to paper documents.

Another difference, for example, is that manufacturing planning, generally includes a bill of materials, discrete assembly of parts into a larger assembly, and a resulting final assembly. When a bill of materials has been determined, it is generally easy to determine the paths that parts and sub-assemblies take through a factory to the final assembly. Solving such problems has been accomplished for many years using, for example, MIP solving techniques.

However, in BPM, no bill of materials is present to provide such a view into the process. Rather, one generally does not know the process that will be followed with a given document until processing of the document has begun. For example, when a bank receives a loan application, processing begins. After initial processing, if the application is denied one set of steps will be taken, but if the application is approved, a different set of steps will be taken.

It is well known in relational database design that primary keys are values that can be used to identify unique rows in a database table. A primary key constraint is satisfied if and only if no two rows in a table have the same non-null values in the unique column(s) of the primary key and none of the values in the specified column(s) are the null value. Likewise, the concept of the foreign key is well known. A foreign key is a field or group of fields in a row that point to the key of another database record, usually in a different table. Often, a foreign key in one table refers to the primary key of another table, linking information in various tables together.

It would be desirable to provide systems and methods for formulating mixed integer programs to represent business process management models for use in resource allocation or resource sizing recommendations.

It would further be desirable to provide systems and methods for formulating MIPs representing BPM models that can be used in conjunction with simulations to refine simulations in a manner that will allow for improved models.

It would further be desirable to provide systems and methods for determining resource assignments in BPM models, simulating business processes, using MIP programming methods to generate resource assignment recommendations, and applying the resource assignment recommendations to future execution to provide an optimal environment.

It would further be desirable to provide mathematical models that represent business process management problems, wherein the mathematical models are mixed integer programs. Such models may largely be defined by providing definitions of relationships between resources, process steps, and time buckets.

It would further be desirable to provide data models that represent BPM problems, wherein the data models are indexed by resources, process steps, and time buckets. The data models may also be indexed by resource category. Such models may be used to generate mathematical models.

### SUMMARY OF THE PRESENT INVENTION

It is an object of the present invention to provide methods and systems for resource allocation using planning oriented techniques to improve advance decisions regarding the quantity of workflow each resource is going to process during each time interval.

It is an object of the present invention to provide methods and systems in which a resource allocation recommendation is generated and then used at dispatching time.

It is an object of the present invention to provide methods and systems for basing document and resource choices for the step queue not only on the content of the step queue, but also on the difference between the resource processing quantities and the resource allocation recommendation.

It is an object of the present invention to provide methods and systems for improving decisions regarding the resource (e.g., human and machine) allocation for achieving a given target throughput.

It is an object of the present invention to provide methods and systems for improving resource sizing, wherein the identification and selection of the number of resources to be used for achieving a target throughput is based upon proposed resource skill profiles and chosen selection criteria, possibly with a minimum and a maximum boundary for resource sizes.

As was mentioned previously, attempting to solve BPM problems through control, rather than planning, is well known. In such attempts, the dispatching algorithm attempts to allocate a document to a resource when the document arrives in a queue without planning for future events. This allocation might prove less than optimal, e.g., where it might be advantageous to wait for some period of time before allocating a document rather than assigning the new work to the next available resource. Thus, one object of the present invention is to provide systems and methods for planning for an optimal BPM solution over time.

It is further an object of the invention to provide systems and methods for formulating mixed integer programs to represent business process management models for use in resource allocation or resource sizing recommendations.

It is further an object of the invention to provide systems and methods for formulating MIPs representing BPM models that can be used in conjunction with simulations to refine simulations in a manner that will allow for improved models.

It is further an object of the invention to provide systems and methods for determining resource assignments in BPM models, simulating business processes, using MIP programming methods to generate resource assignment recommendations, and applying the resource assignment recommendations to future execution to provide an optimal environment.

It is further an object of the invention to provide mathematical models that represent business process management problems, wherein the mathematical models are mixed integer programs. Such models may largely be defined by providing definitions of relationships between resources, process steps, and time buckets.

It is further an object of the invention to provide data models that represent BPM problems, wherein the data models are indexed by resources, process steps, and time buckets. The data models may also be indexed by resource category. Such models may be used to generate mathematical models.

These and other objects of the present invention are accomplished by providing systems and methods for resource allocation and resource sizing using mixed integer programming, wherein the data model and the mathematical model are common for both resource allocation and resource sizing.

The present invention generally encompasses a software program operating on a computer including a general purpose microprocessor that implements methods for using mixed integer programming for improving resource allocation and resource sizing.

In one embodiment of the invention, a business process management problem is formulated as a mixed integer program. The program is solved to generate a resource allocation recommendation or a resource sizing recommendation. The process may be simulated to determine a projected outcome. If the projected outcome is not as good as desired, the solution of the MIP may be used to refine the model such that it is likely to provide a better outcome in future simulations or executions. This refining process may be repeated multiple times in attempts to improve resource allocation or resource sizing recommendations.

In another embodiment of the invention, a resource assignment for a business process may be determined, and a MIP representing the process is solved to generate a resource assignment recommendation.

In another embodiment of the invention, a mathematical model is provided for modeling a BPM problem as a mixed integer program. This MIP may include an objective function, equations defining the relationships between two or more steps, resources, and time buckets. The relationships may be between items in different categories or items in the same category. Optionally, the model may define the relationship between resource category skills and other aspects of the process.

In another embodiment of the invention, a data model is provided for representing a BPM problem. The data model may be indexed by steps, resources, and time buckets. This model may include competency relationships between resources and queue steps, queue mappings between steps and time buckets, availability relationships between resources and time buckets, and arc relationships defining work flow between steps in the process. The model may include further indexes and relationships.

### BRIEF DESCRIPTION OF THE DRAWINGS

FIG. 1 shows a block representation of one example of a data model.

FIG. 2 shows a block representation of a second example of a data model.

FIG. 3 shows a functional diagram illustrating one manner in which the present invention may be used.

FIG. 4 shows a block representation of a third example of a data model.

### DETAILED DESCRIPTION OF THE INVENTION

Among the issues encountered when using BPM to monitor and plan the implementation of business processes and business rules are resource allocation and resource sizing.

When considering resource allocation, the inputs can be placed into categories such as production infrastructure, flow graph or flow chart, fixed resources (e.g., staff members having available work times and skill sets), and input flow. The resource allocation output is generally a definition of the amount of time each resource should spend on each step for each period of time and the throughput that this allocation permits. To determine this allocation, an objective function maximizing throughput is generally applied. A secondary objective of minimizing cost while retaining the maximum throughput may be applied. By using such a secondary objective, a less costly allocation that reaches the same throughput may be determined. Additional soft constraints within a resource allocation problem may include load balancing constraints to strive for fairness in work loads between employees or early production constraints which will allow for an early push such that a later delay will not hinder reaching the target throughput.

Generally, the invention described herein allows for an increase or maximization of the throughput, a decrease or minimization of cost, or both. In some problems, however, differing goals may be sought by weighting different factors in the objective function. This resource allocation recommendation may be used by applying dispatching rules that closely or exactly follow the recommendation.

When considering resource sizing, the inputs can be placed into categories such as production infrastructure, flow graph or flow chart, resources (e.g., teams having hiring costs, hourly costs, and skills, but with unknown size), and target throughputs. The resource sizing output is generally a definition of the least costly set of resources that can achieve the target throughput. However, differing goals (e.g., minimal hiring costs, minimal hourly costs, broad skill sets, specialized skill sets, etc.) may be weighted in varying manners in the objective function.

The resource sizing recommendation may be used to determine whether and how to acquire, maintain, or divest resources (e.g., permanent employees, temporary employees, contract employees, hardware resources, software licenses, machine resources, merger or acquisition strategy, etc.).

In one embodiment of the invention, the data model for both resource allocation and resource sizing may be the same. However, the models will likely have functional differences in that one or more of the input constraints (or constants) in one model appear as output (or variables) in the other model. More precisely, resource size is an output of resource sizing and an input for resource allocation. At least two techniques exist for reducing these differences. First, variables and constants may be amalgamated using upper bounds and lower bounds for selected inputs or outputs. Second, multiple objective functions may be created, each weighting some or all factors differently that the others. (This second approach is also used in Goal Programming, wherein some objectives are treated as constraints by adding slack or surplus variables to represent deviation from a goal.) The multiple objective approach allows prioritization of an objective based on whether the user is focused on resource allocation or resource sizing.

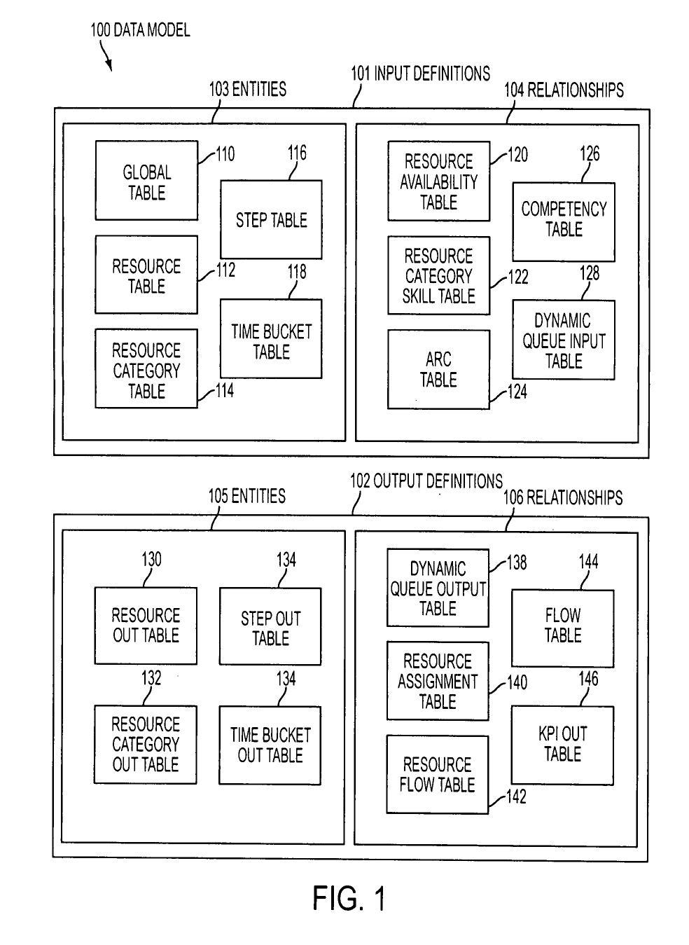

FIG. 1 is a block representation of one example of a data model 100 according to this invention. Data model 100 may be created using, for example, relational database design. The data model 100 will comprise two primary portions, a set of input definitions 101 and a set of output definitions 102. The input definition 101 can be defined as including both entities 103 and relationships 104. Likewise, the output definitions 102 can be defined as including both entities 105 and relationships 106.

For the input definition 101, the entities 103 may include a global table 110, a resource table 112, a resource category table 114, a step table 116, and a time bucket table 118. Each of the tables described herein may hold multiple rows of data.

The global table 110 may be defined to include a primary key comprising the parameter name and a field for the parameter value. The parameter name field may be used to store indexless parameter names. The parameter value field may be used to store the value of such parameters. For example, parameters for maximum throughput, maximum cost per item, minimum cost per item, or minimum throughput may be stored in the global table. These parameters may be assigned value in the parameter value field. In one implementation of such a field, the non-negative numbers may represent actual values, while the number −1 may represent infinity. For example, the value of the maximum throughput parameter may be set to −1 if maximum throughput should not be limited.

The resource table 112 may be defined to include a primary key comprising the resource ID and fields for resource name, cost per time unit, resource category ID, fixed cost per individual resource, minimum number of units, maximum number of units, and maximum steps per bucket. In resource table 112, the resource category ID is a foreign key of the resource category ID from resource category table 114. The data placed in these fields may take the following form. The resource ID may be a unique identifier such as a serial number or social security number. The resource name may be a job description or machine type. The cost per time unit may be the cost to use a resource for a given amount of time, such as an hourly wage or the cost of electricity to keep a machine on standby power. The resource category ID may be a unique identifier for a category into which the resource falls. Resource categories may be used to represent a set of resources having the same or very similar skills, but not necessarily identical in all aspects (e.g., differing cost or production speed). The fixed cost per individual resource may be a fixed cost that is incurred when that resource is included in the business process, whether the optimal solution includes the use of the resource or not. For example, a certain fixed cost such as salary may be incurred by having an employee on staff at a company, whether or not the employee is engaged in work. The minimum number of units may be the minimum number of individuals having the skill-set described by the resource. The maximum number of units may be the maximum number of individuals having the skill-set described by the resource. In resource sizing, this number is generally unknown or partially known. If known, the minimum number equals the maximum number. If the number is unknown, then the minimum is set to zero, and the maximum is infinity. If the number is partially known, the minimum and maximum values may be adjusted to incorporate the partial knowledge. The maximum steps per bucket may be the maximum number of individual process steps that a particular resource can perform in a particular time period (or time bucket). The maximum steps may be very high for certain step/resource combinations, and thus, may be modeled as infinite.

The resource category table 114 may be defined to include a primary key comprising the resource category ID and fields for resource category name, maximum category size, and minimum category size. The resource category ID is a unique identifier for the various resource categories. The resource category name may be a descriptor that identifies the category into which the resource falls, such as loan officer, high-speed printer, database search software, etc. The maximum category size is the maximum allowed number of resources of the unique category. The minimum category size is the minimum allowed number of resources of the unique category.

The step table 116 may be defined to include a primary key comprising the step ID and fields for the step name and initial queue size. The step ID is a unique identifier for a particular step within the business process. The step name may be a recognizable description of the step, such as decline application, email customer, initiate transaction, etc. The initial queue size may be a number indicating the number of documents queued to flow through the process step at time zero.

The time bucket table 118 may be defined to include a primary key comprising the bucket number and fields for the bucket name and bucket duration. The bucket number is a unique identifier for a given block of time, referred to as a bucket. The bucket name may be a recognizable description of the bucket, such as day shift, evening shift, 8:00 am to 9:00 am, etc. The bucket duration is the maximum amount of time within a given bucket.

For the input definition 101, the relationships 104 may include a resource availability table 120, a resource category skill table 122, an arc table 124, a competency table, 126, and a dynamic queue input table 128.

The resource availability table 120 may be defined to include a primary key comprising the resource ID and bucket number and a field for the available time. In resource availability table 120, the resource ID is a foreign key of the resource ID from resource table 112, while the bucket number is a foreign key of the bucket number in time bucket table 118. The available time for a given row should be less than or equal to the product of the bucket duration and the resource size for the identified bucket number and resource ID combination.

The resource category skill table 122 may be defined to include a primary key comprising the resource category ID and step ID. The resource category ID in table 122 is a foreign key of the resource category ID in table 114, while the step ID in table 122 is a foreign key of the step ID in table 116. Table 122 is used to map resources to steps of the process that can be performed by the resource. For example, a resource category that was defined to model a very skilled employee may be mapped to many different types of process steps by inserting multiple rows of data in the table wherein the relevant resource category ID remains static and the step ID changes in each row. On the other hand, a resource category denoting a new trainee might only be mapped to a single step within this table.

The arc table 124 may be defined to include a primary key comprising a “from step ID” and a “to step ID” and a field for the percentage. The from step ID and to step ID in table 124 are each foreign keys of the step ID in table*116. The “from step ID” denotes the step from which the process flow progressed. The “to step ID” denotes the step to which the process flow will progress. For example, some steps may have multiple output arcs, which would be modeled as multiple rows in the table having the same from step ID and different to step ID for each different arc. The percentage field may be used to indicate, for each row, the probability that the process will flow from the identified “from” step to the identified “to” step.

The competency table 126 may be defined to include a primary key comprising the resource ID and step ID and a field for the duration per document per resource unit. The resource ID in table 126 is a foreign key of the resource ID in table 112. The step ID in table 112 is a foreign key of the step ID in table 116. The competency table may be used to map particular resources to the process step or steps which the particular resource is competent to perform. The duration per document per resource unit field may be used to indicate how long a given resource takes to process a single item in a particular step. This may vary for different resource—step combinations.

The dynamic queue input table 128 may be defined to include a primary key comprising the step ID and bucket number and a field for the external queue input. The step ID in table 128 is a foreign key of the step ID in table 116. The bucket number in table 128 is a foreign key of the bucket number in table 118. Table 128 may be used to map the relationship between steps and time buckets. The external queue input may be used to indicate that a particular step—bucket combination is a point wherein workflow may enter the business process. In some business processes, workflow may enter at any process step at any time, whereas in others the entry may be more restricted.

For the output definition 102, the entities 105 may include a resource out table 130, a resource category out table 132, a step out table 134, and a time bucket out table 136.

The resource out table 130 may be defined to include a primary key comprising the resource ID and a field for the number of units. The resource ID may be a unique identifier such as a serial number or social security number. The number of units may indicate the quantity of a given resource. It is preferable that the solution for number of units in table 130 fall within the limits fixed by the maximum number of units and minimum number of units of table 112.

The resource category out table 132 may be defined to include a primary key comprising the resource category ID and a field for the category size. The resource category ID is a unique identifier for the various resource categories. The category size may indicate the quantity of a given resource category. It is preferable that the solution for category size in table 132 fall within the limits fixed by the maximum category size and minimum category size of table 114.

The step out table 134 may be defined to include a primary key comprising the step ID and a field for the final queue size. The step ID is a unique identifier for a particular step within the business process. The final queue size may indicate the size of the workflow queued to be processed through the identified step at the end of the modeled processing time.

The time bucket out table 136 may be defined to include a primary key comprising the bucket number and a field for the quantity processed in bucket. The bucket number is a unique identifier for a given block of time. The quantity processed in bucket may be used to indicate the amount of workflow, e.g. documents, processed during the identified time period.

For the output definition 102, the relationships 106 may include a dynamic queue output table 138, a resource assignment output table 140, a resource flow table 142, a flow table 144, and a KPI out table 146.

The dynamic queue output table 138 may be defined to include a primary key comprising the step ID and bucket number and fields for the start queue size, quantity received, and quantity processed. The step ID in table 138 is a foreign key of the step ID in table 134. The bucket number in table 138 is a foreign key of the bucket number in table 136. Table 138 is used to map particular process steps to particular buckets. The start queue size may indicate the amount of workflow to be processed through the identified step at the beginning of the identified bucket. The quantity received may indicate the amount of workflow received to be processed through the identified step during the identified bucket. If used in this manner, the quantity received will be set equal to the sum of all input flows for the identified step ID and bucket number combination. The quantity processed may indicate the amount of workflow processed through the identified step during the identified bucket. If used in this manner, the quantity processed is equal to the sum of the workflows processed through the identified step during the identified bucket by all resources that process workflow for the identified step—bucket combination.

The resource assignment output table 140 may be defined to include a primary key comprising the resource ID, step ID, and bucket number and fields for the quantity processed by resource, resource time, quantity available same bucket, quantity available next bucket, and whether the resource is active. The resource ID in table 140 is a foreign key of the resource ID in table 130. The step ID in table 140 is a foreign key of the step ID in table 134. The bucket number in table 140 is a foreign key of the bucket number in table 136. The quantity processed by resource may indicate the amount of workflow processed through the identified step by the identified resource during the identified bucket. The resource time may indicate the product of the amount of workflow and the time per unit of workflow processed through the identified step by the identified resource during the identified bucket. The quantity available same bucket may be used to store the quantity that is available for processes during the same bucket. The quantity available next bucket may be used to store the quantity that is available for processes during the next bucket. The “whether the resource is active” field may be used to indicate whether the identified resource has processed workflow through the identified step during the identified bucket. Meaningful entries in table 142 will be limited by the pairings of resource ID and step ID in table 126 and the pairings of resource ID and bucket number in table 120.

The resource flow table 142 may be defined to include a primary key comprising the resource ID, from step ID, to step ID, “from bucket number,” and “to bucket number” and a field for the flow quantity. The resource ID in table 142 is a foreign key of the resource ID in table 130. The from step ID in table 142 is a foreign key of the step ID in table 134. The from bucket number in table 142 is a foreign key of the bucket number in table 136. The to step ID in table 142 is a foreign key of the step ID in table 134. The to bucket number in table 142 is a foreign key of the bucket number in table 136. In table 142, the flow quantity may be used to indicate the quantity of a given resource sent from the identified “from” step and the identified “from” bucket to the identified “to” step and the identified “to” bucket.

The flow table 144 may be defined to include a primary key comprising the from step ID, to step ID, from bucket number, and to bucket number and a field for the flow quantity. The from step ID in table 144 is a foreign key of the step ID in table 134. The from bucket number in table 144 is a foreign key of the bucket number in table 136. The to step ID in table 144 is a foreign key of the step ID in table 134. The to bucket number in table 144 is a foreign key of the bucket number in table 136. In table 144, the flow quantity may be used to define the number of items moving from the step represented by “from step ID” to the step represented by “to step ID,” which depart during the time period represented by “from bucket number” and arrive during the time period represented by “to bucket number.”

The KPI out table 146 may be defined to include a primary key comprising the KPI name and a field for the KPI value. The KPI name is a unique identifier for a key performance indicator (“KPI”). The identifier may be descriptive or non-descriptive of the KPI. The KPI value may be used to indicate the value or penalty associated with the identified KPI.

Data assigned to the tables in data model 100 may be expressed as part of an MIP, using known methods for creating a MIP from such constraints and objectives. For example, for each resource category ID, one of skill can transform the maximum category size and minimum category size of table 114 into a set of MIP limitations such that the category size of table 132 is not permitted to exceed the maximum or be less than the minimum set forth in table 114. Some of the tables or fields may be expressed as constraints, while others may be expressed as objectives. Additional constraints such as defining the cost per item within a range or with a maximum value may be added. Likewise, one or more constraints setting throughput requirements within a range, less than a maximum value, greater than a minimum value, etc. may be added. The manner of doing so will vary depending on the goals for the model as a whole as well as whether the goal is resource sizing or resource allocation.

One of skill in the art will recognize that the above model is an example, and that other model structures will fall within the spirit of the invention described herein. For example, in the above model, some tables, fields, or relationships may be modified, expanded, shrunk, or eliminated while retaining much of the functionality and value of the model. Some business processes or analyses may demand the addition, deletion, or redefinition of tables. Thus, it would be impossible to list all the specific model configurations that would fall within the scope of the invention disclosed herein. Accordingly, data model 100 is set forth as an example data model that may be used in accordance with the present invention.

Having modeled the BPM problem as a MIP, the user has the option of applying the problem to either resource allocation or resource sizing by applying a MIP solver to the model. The mathematical model is common for both resource allocation and resource sizing. One example of a MIP solver that may be used is software sold under the name CPLEX by ILOG, Inc. of Mountain View, Calif.

When resource allocation is the goal, a MIP solver is applied to the MIP to generate a resource allocation recommendation. This recommendation may then be used by the dispatcher to dispatch documents. When using the resource allocation recommendation, the recommendation allows the dispatcher to determine which document to choose from the step queue, to what resource the document should be assigned, and when to assign the document to the resource. Thus, dispatching decisions may be based not only on the content of the step queue, but also on the difference between the quantity of documents processed by the dispatching time and the resource allocation recommendation. Resource allocation is generally well suited for tactical decision support.

In one example of a resource allocation problem, the resource sizes (e.g. staff) is firm. The desired output from the MIP solver is a prediction of the best resource allocation for each time bucket. This output (i.e., the resource allocation recommendation) may be used in applying a rule based dispatching system. An example of a typical rule might be: for each step queue, choose the highest priority item in the queue determined by the earliest arrival time and dispatch the item to a resource, wherein the resource is chosen by calculating the difference between the recommendation and the processing history for each resource. One method of determining the appropriate resource is to choose the resource wherein this difference is largest when expressed as a percentage.

When employing a resource allocation goal, recalculation of the resource allocation recommendation may be performed before the calculation horizon is reached. For example, a resource allocation recommendation with a one week horizon may be recalculated every day. Or, if the resource allocation recommendation is based on ½ day time buckets, the recommendation may be recalculated every half day. In this manner, the decision horizon based upon the recommendation may be much shorter than the calculation horizon. Thus, resource allocation may be recalibrated based on recent processing results. The decision to recalculate may be based on a fixed frequency, based on the observation that the size of one or more observed queues significantly diverge from the recommendation, or other considerations more specific to a given problem or goal.

When resource sizing is the goal, a MIP solver is applied to the MIP to generate a resource sizing recommendation. The resource sizing recommendation may be used to decide upon the resource set (e.g., the staff and machines) that will be best for achieving a given target throughput. This resource sizing recommendation will allow choosing among possible resource skill profiles, the best (according to desired criteria) number of resources for each profile, possibly with a minimum and maximum value for each type of resource. Resource sizing is generally well suited for strategic decision support.

In one example of a resource sizing problem, a target throughput is chosen. The size of certain parts of the staff or other resources may be firm, while other parts of the staff or resources may be left unrestrained or constrained in some manner (e.g., maximum, minimum, or within a range). An objective function, e.g., minimizing resource hiring cost or minimizing the sum of resource hiring cost and resource time cost, is applied. The MIP is solved, and the output is the resource sizing recommendation. This output will provide both resource size and the allocation of each resource.

In an extension of this example, the resource sizing allocation may be used to firm the resource sizes. The MIP may be solved again with a throughput maximization objective. The user may determine whether the maximum throughput is too close to the target throughput. That is, the possibility of reaching the target throughput might be lower than desired if the maximum throughput is too low. If the maximum throughput is too low, based on criteria determined by the user, the model may be adjusted to provide some slack between the maximum throughput and the target throughput. One manner of providing this slack is to relax restrictions on staff or other resources and adjust the model to reflect a higher target throughput. The MIP may be solved again to generate a new resource sizing recommendation. This will allow for safer resource sizing. With the safer resource sizing in place, the user can solve the MIP again with a resource time cost minimization goal. In this manner, the user may reduce the risk that the target throughput will not be reached.

Possible objectives that may be used for either resource sizing or resource allocation include minimization of resource costs (e.g., the sum over all resources of each resource's cost per time unit times that resource's processing time), minimization of resource hiring cost (e.g., the sum over all resource types of the resource type's hiring cost times the resource type's size), and maximization of throughput.

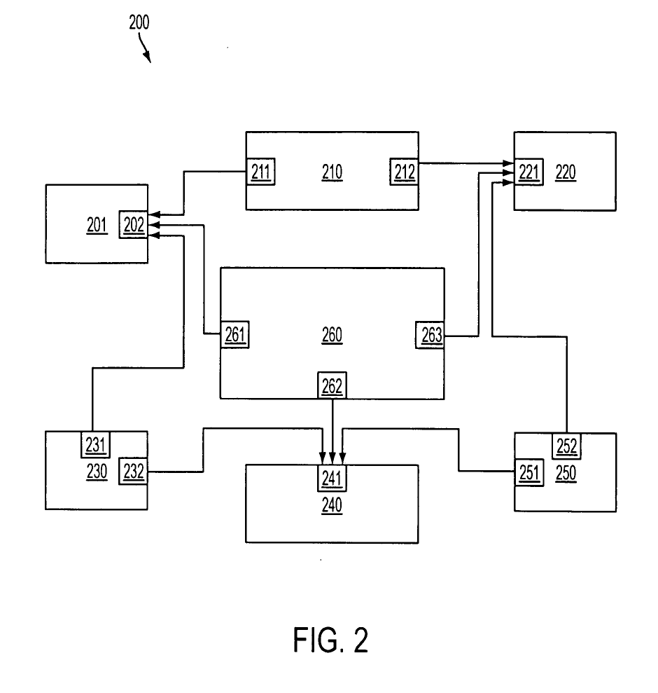

FIG. 2 is a block representation of an example of a data model 200 according to the present invention. Data model 200 may be created using, for example, relational database design. One possible mathematical model of data model 200 is set forth in connection with the description of data model 200.

The data model 200 may include a resource (r) table 201, a competency (r,n) table 210, a node (n) table 220, a resource availability (r,t) table 230, a time bucket (t) table 240, a node workload (n,t) table 250, and a resource assignment (r,n,t) table 260. Each of the tables described herein may hold multiple rows of data.

The resource (r) table 201 may be defined to include a primary key comprising the resource ID 202 and a field for the cost of the resource per time unit (C(r)).

The node (n) table 220 may be defined to include a primary key comprising the node ID 221.

The time bucket (t) table 240 may be defined to include a primary key comprising the bucket number (t) 241 and a field for the bucket duration (D(t)).

The competency (r,n) table 210 may be defined to include a primary key comprising the resource ID 211 and node ID 212 and a field for the work duration per task (WK(r,n)). The resource ID 211 is a foreign key of the resource ID 202. The node ID 212 is a foreign key of the node ID 221. Table 210 is used to map particular resources r to particular nodes n. The work duration per task field (WK(r,n)) may indicate the amount of time required for a given resource r to perform the task required by a given node n. If a given resource r cannot perform a given task, the resource-node combination (r,n) may be left out of table 210 or the work duration per task field WK(r,n) may be set to a very high number for the resource-task combination.

The resource availability (r,t) table 230 may be defined to include a primary key comprising the resource ID 231 and bucket number 232 and a field for the available time (AT(r,t)). The resource ID 231 is a foreign key of the resource ID 202. The bucket number 232 is a foreign key of the bucket number 241. Table 230 is used to map particular resources r to particular buckets t. The available time field AT(r,t) may indicate the amount of time a given resource r has available in a given bucket t. If a given resource r has no time in a given bucket t, the resource-bucket combination (r,t) may be left out of table 230 or the available time field AT(r,t) may be set to zero for the resource-bucket combination.

The node workload (n,t) table 250 may be defined to include a primary key comprising the bucket number 251 and node ID 252 and fields for the number of tasks (NT(n,t)) and missing time (XMT(n,t)). The bucket number 251 is a foreign key of the bucket number 241. The node ID 252 is a foreign key of the node ID 221. Table 250 is used to map particular buckets t to particular nodes n. The number of tasks field NT(n,t) may indicate the number of tasks that must be performed at a given node n during a given bucket t. If a given node n has no tasks in a given bucket t, the node-bucket combination may be left out of table 250 or the number of tasks field NT(n,t) may be set to zero for the node-bucket combination. The missing time field XMT(n,t) is used to store an output denoting missing tasks for the node-bucket combination.

The resource assignment (r,n,t) table 260 may be defined to include a primary key comprising the resource ID 261, bucket number 262 and node ID 263 and fields for the number of tasks assigned to the resource-node-bucket combination (XNTA(r,n,t)) and the resource time (XRT(r,n,t)). The resource ID 261 is a foreign key of resource ID 202. The bucket number 262 is a foreign key of the bucket number 241. The node ID 263 is a foreign key of the node ID 221. Table 260 is used to map particular buckets t to particular nodes n and particular resources r. The number of tasks field XNTA(r,n,t) may indicate the number of tasks that must be performed by a given resource r at a given node n during a given bucket t. The resource time field XRT(r,n,t) is used to store an output denoting the amount of time that a resource r works on a given node n during a given bucket t for each resource-node-bucket combination.

In this example, the primary indexes are resource ID (r) 202, bucket number (t) 241, and node ID (n) 221. Constants that are input into the problem are stored in the number of tasks field NT(n,t) in table 250, the work duration per task field WK(r,n) in table 210, the available time field AT(r,t) in table 230, and the cost per time unit field C(r) in table 201. Decision variables are mapped to the number of tasks assigned field XNTA(r,n,t) in table 260. Deduced variables are mapped to the resource time field XRT(r,n,t) in table 260. Slack variables are mapped to the missing time field XMT(n,t) in table 250.

Hard constraints in this example include constraints to respect competency (RComp(r,n,t) and constraints to respect resource availability (ResAvail(r,t)). The constraints to respect competency constrain the resource assignment so that the time a resource works on a node during a time period is equal to the work duration for the resource to do the task required by the node multiplied by the number of tasks assigned to the resource-node-bucket combination for each resource-node-bucket combination. RComp(r,n,t) may be represented as: ∀r,n,t; XRTᵣₙₜ=WK_{r,n}×XNTAᵣₙₜ. The constraints to respect resource availability are constrain the resource assignment so that the time a resource works on a node during a bucket is less than or equal to the time that the resource has available in the bucket, for each resource-bucket combination. ResAvail(r,t) may be represented as: ∀r,t; Σₙ XRTᵣₙₜ≦ATᵣₜ.

Soft constraints may include constraints to respect node workloads RNW(n,t). These constraints constrain the node workload assignments so that for all node-bucket combinations, the number of tasks required by a node-bucket combination is equal to the missing tasks for the node-bucket combination plus the sum over all resources of the number of tasks assigned to the resource-node-bucket combination. RNW(n,t) may be represented as: ∀n,t; Σᵣ XNTAᵣₙₜ+XMTₙₜ=NTₙₜ. When used in goal programming, these soft constraints may include slack variables.

This example may include feasibility objectives (FeasObjₜ) and a cost objective (CostObj). The feasibility objective FeasObjt for each bucket is to minimize the sum over all nodes of the missing tasks for the node-bucket combination, which may be represented as: ∀t(OtoH); FeasObjₜ=minΣₙ XMTₙₜ. The cost objective CostObj is to minimize the sum over all resources, nodes, and buckets of the cost per time unit for a resource times the amount of time that the resources works at a node during a bucket, which may be represented as: CostObj=minΣ_{r,n,t} Cᵣ×XRT_{r,n,t}.

The following pseudo-code denotes one possible method for generating the matrix of equations to be used in this example:

```
New obj CostObj
Loop on time bucket table (t)
    New obj FeasObj(t) min
End Loop
Loop on node workload table (n,t)
    New var XMT(n,t)
    New constraint RNW(n,t) with RHS=(“=”,NT(n,t))
    Coef(XMT(n,t), RNW(n,t))=1
    Coef(XMT(n,t),FeasObj(t))=1
End Loop
Loop on resource availability table (r,t)
    New constraint ResAvail(r,t) with
    RHS=(“≦”,AT(r,t))
End Loop
Loop on competency table (r,n)
    Loop on time bucket table (t) such that (n,t) in
    workload
      New var XNTA(r,n,t)
      New var XRT(r,n,t)
      New constraint RComp(r,n,t) with RHS=(“=”,0)
      Coef(XNTA(r,n,t),RComp(r,n,t))=WK(r,n)
      Coef(XRT(r,n,t),RComp(r,n,t))=−1
      Coef(XRT(r,n,t),ResAvail(r,t))=1
      Coef(XRT(r,n,t),RNW(n,t))=1
      Coef(XRT(r,n,t),CostObj)=C(r) min
    End Loop
End Loop
```

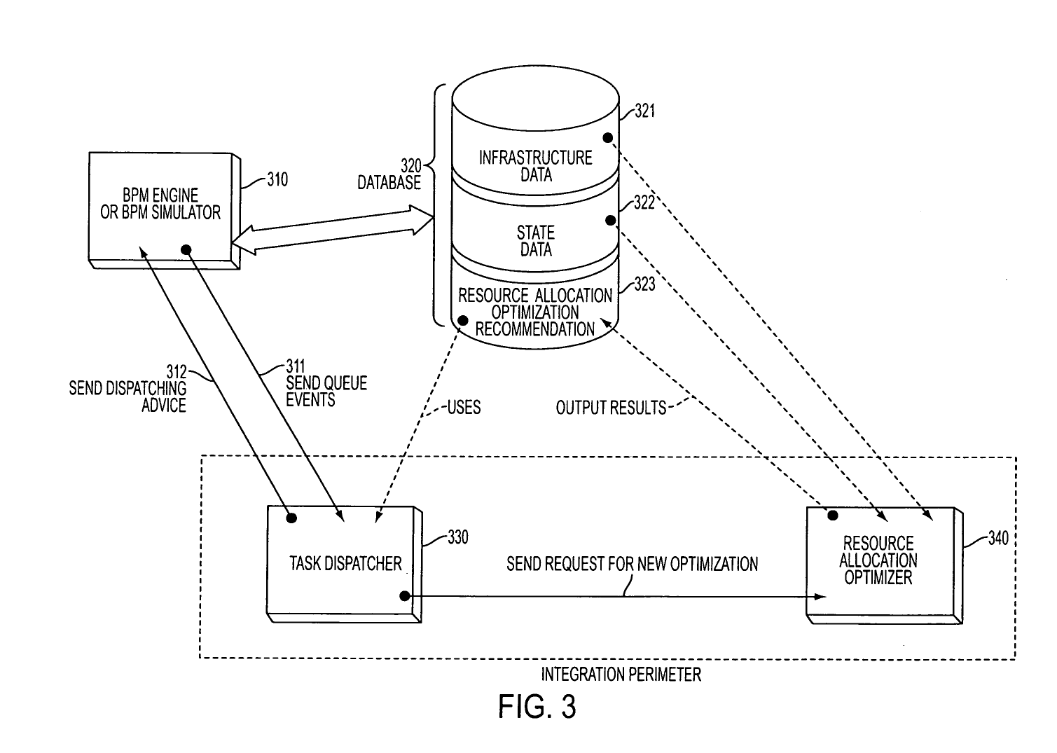

FIG. 3 sets forth a functional diagram illustrating a possible method of using the present invention. This method may be used, for example, with the model 200 or model 400.

In this example, the BPM engine 310 sends queue events 311 (e.g., the events occurring when a new document arrived in a step queue or a resource queue became empty) to task dispatcher 330. In addition to receiving events 311 from BPM engine 310, the task dispatcher 330 has real time access to the step and resource queues (not shown). Based on the knowledge gained by the foregoing, the task dispatcher 330 sends dispatching recommendations 312 to the BPM engine 310. For example, task dispatcher 330 may recommend that BPM engine 310 send a document from a step queue to a resource queue (not shown). The task dispatcher 330 uses the current resource allocation recommendation 323. Recommendation 323 (also referred to as plan 323) is created by and output from resource allocation optimizer 340. Recommendation 323 may be stored in database 320 along with infrastructure data 321 and state data 322. Observation by dispatcher 330 that the plan 323 is further than allowable from execution reality triggers the resource allocation optimizer 340 to generate a new resource allocation optimization. To do so, optimizer 340 reads infrastructure data 321 and state data 322 from database 320. Optimizer 340 the generates the new plan 323 using mixed integer programming techniques. After generating the plan 323, optimizer 340 updates the plan 323 in the database 320. Dispatcher 330 may subsequently use recommendation 323.

At any point in this process, a determination of whether to continue optimizing may be made. The determination may be based on a goal of satisfying the problem, improving the problem, limiting the number of iterations of the process, or other criteria. One possible criterion that may be used is a determination of whether an objective has been reached. Another possible criterion is a determination of whether the value of the objective function is increasing by more than a desired percentage or amount in the most recent iteration of optimization. Objectives that are often used include resource cost, resource usage, and throughput.

If it is determined to continue the process, in iterations after the first iteration, database 320 may provide recommendations 323 to dispatcher 330.

The following discussion provides one example of how resource assignment recommendations may be used in execution. For a given node n in the process, the dispatching mechanism may be provided with a rule to choose resource r for a given document such that r can perform the task required by n, the number of tasks assigned XNTA(r,n,t) is greater than the number of tasks that have already been used, and resource r will be available within a chosen number of minutes.

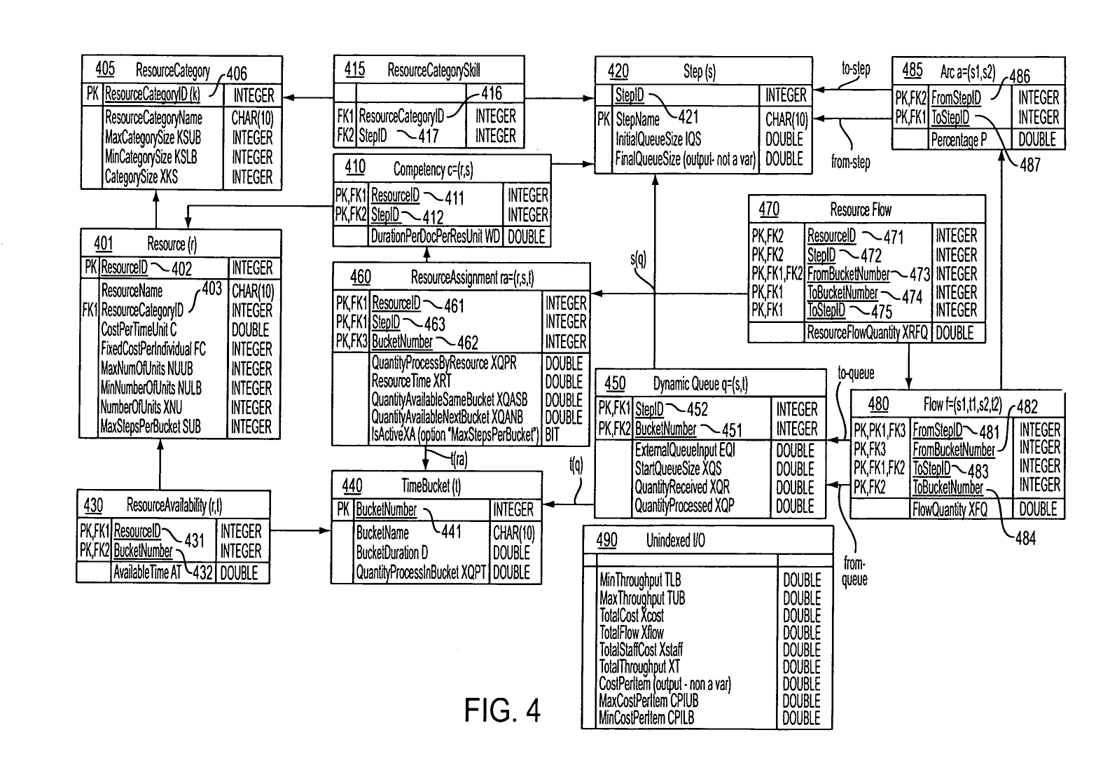

FIG. 4 is a block representation of an example of a data model 400 according to the present invention. Data model 400 may be created using, for example, relational database design. One possible mathematical model of data model 400 is set forth in connection with the description of data model 400.

The data model 400 may include a resource (r) table 401, a competency (c=(r,s)) table 410, a step (s) table 420, a resource availability (r,t) table 430, a time bucket (t) table 440, a dynamic queue (q=(s,t)) table 450, a resource assignment (ra=(r,s,t)) table 460, a resource category table 405, a resource category skill table 415, an arc (a=(s1,s2)) table 485, a resource flow table 470, a flow (f=(s1,t1,s2,t2)) table 480, and an unindexed input/output table 490. Each of the tables described herein may hold multiple rows of data.

The resource (r) table 401 may be defined to include a primary key comprising the resource ID (r) 402 and fields for the resource name, resource category ID 403, cost per time unit (C), fixed cost per individual (FC), maximum number of units (NUUB), minimum number of units (NULB), number of units (XNU), and maximum steps per bucket (SUB). The fields may be further defined in the following manner: resource ID 402, resource category ID 403, fixed cost per individual (FC), maximum number of units (NUUB), minimum number of units (NULB), number of units (XNU), and maximum steps per bucket (SUB) may be integers; resource name may be a 10 byte character; and cost per time unit (C) may be a double floating point number. The resource category ID 403 is a foreign key of resource category ID 406.

The step (s) table 420 may be defined to include a primary key comprising the step ID (s) 421 and fields for step name, initial queue size (IQS), and final queue size (which is an output). The fields may be further defined in the following manner: step ID 421 may be an integer; step name may be a 10 byte character; initial queue size (IQS) and final queue size may be double floating point numbers.

The time bucket (t) table 440 may be defined to include a primary key comprising the bucket number (t) 441 and fields for the bucket name, bucket duration (D), and quantity process in bucket (XQPT). The fields may be further defined in the following manner: bucket number (t) 441 may be an integer; bucket name may be a 10 byte character; bucket duration (D) and quantity process in bucket (XQPT) may be double floating point numbers.

The competency (c=(r,s)) table 410 may be defined to include a primary key comprising the resource ID (r) 411 and step ID (s) 412 and a field for the duration per document per resource unit WD. The fields may be further defined in the following manner: resource ID 411 and step ID 412 may be integers; duration WD may be a double floating point number. The resource ID 411 is a foreign key of the resource ID 402. The step ID 412 is a foreign key of the step ID 421. Table 410 is used to map particular resources r to particular steps s. The duration field (WD) may indicate the amount of time required for a given resource unit to process a given document related to a step s. If a given resource r cannot perform a given task, the resource-step combination c may be left out of table 410 or the duration field WD may be set to a very high number for the resource-task combination.

The resource category skill table 415 may be defined to include fields for the resource category ID 416 and step ID 417. The fields may be further defined in the following manner: resource category ID 416 and step ID 417 may be integers. The resource category ID 416 is a foreign key of the resource category ID 406. The step ID 417 is a foreign key of the step ID 421. Table 410 is used to map particular resource categories to particular steps s.

The resource category table 405 may be defined to include a primary key comprising the resource category ID (k) 406 and fields for the resource category name, maximum category size (KSUB), minimum category size (KSLB), and category size (XKS). The fields may be further defined in the following manner: resource category ID k 406, maximum category size KSUB, minimum category size KSLB, and category size XKS may be integers; resource category name may be a 10 byte character.

The resource availability (r,t) table 430 may be defined to include a primary key comprising the resource ID (r) 431 and bucket number (t) 432 and a field for the available time (AT). The fields may be further defined in the following manner: resource ID 431 and bucket number 432 may be integers; available time AT may be a double floating point number. The resource ID 431 is a foreign key of the resource ID 402. The bucket number 432 is a foreign key of the bucket number 441. Table 430 is used to map particular resources r to particular buckets t. The available time field AT may indicate the amount of time a given resource r has available in a given bucket t. If a given resource r has no time in a given bucket t, the resource-bucket combination (r,t) may be left out of table 430 or the available time field AT may be set to zero for the resource-bucket combination.

The dynamic queue (q=(s,t)) table 450 may be defined to include a primary key comprising the bucket number (t) 451 and step ID (s) 452 and fields for the external queue input (EQI), start queue size (XQS), quantity received (XQR), and quantity processed (XQP). The fields may be further defined in the following manner: step ID 452 and bucket number 451 may be integers; external queue input EQI, start queue size XQS, quantity received XQR, and quantity processed XQP may be double floating point numbers. The bucket number 451 is a foreign key of the bucket number 441. The step ID 452 is a foreign key of the step ID 421. Table 450 is used to map particular buckets t to particular steps s.

The resource assignment (r,s,t) table 460 may be defined to include a primary key comprising the resource ID (r) 461, bucket number (t) 462 and step ID (s) 463 and fields for the quantity processed by resource (XQPR), resource time (XRT), quantity available same bucket (XQASB), quantity available next bucket (XQANB), and whether the item is active (XA). The fields may be further defined in the following manner: resource ID 461, step ID 463, and bucket number 462 may be integers; quantity processed by resource (XQPR), resource time (XRT), quantity available same bucket (XQASB), quantity available next bucket (XQANB) may be double floating point numbers; and whether the item is active (XA) may be a bit. The resource ID 461 is a foreign key of resource ID 402. The bucket number 462 is a foreign key of the bucket number 441. The step ID 463 is a foreign key of the step ID 421. Table 460 is used to map particular buckets t to particular steps sand particular resources r. The resource time field XRT is used to store an output denoting the amount of time that a resource r works on a given step s during a given bucket t for each resource-step-bucket combination.

The arc (a=(s1,s2)) table 485 may be defined to include a primary key comprising the from step ID (s1) 486 and to step ID (s2) 487 and a field for the percentage P. The fields may be further defined in the following manner: from step ID 486 and to step ID 487 may be integers; percentage P may be a double floating point number. The from step ID 486 and to step ID 487 are foreign keys of the step ID 421. Table 485 is used to map the flow of documents from one step s1 to another step s2. The percentage field P may indicate the probability that a given arc a is followed. Mapping the table in this manner assumes instantaneous transportation from one step to another. Where transportation is not instantaneous, appropriate modifications may be made.

The resource category skill table 415 may be defined to include fields for the resource category ID 416 and step ID 417. The fields may be further defined in the following manner: resource category ID 416 and step ID 417 may be integers. The resource category ID 416 is a foreign key of the resource category ID 406. The step ID 417 is a foreign key of the step ID 421. Table 410 is used to map particular resource categories to particular steps s.

The resource flow table 470 may be defined to include a primary key comprising the resource ID 471, step ID 472, from bucket number 473, to bucket number 474, and to step ID 475 and a field for the resource flow quantity (XRFQ). The fields may be further defined in the following manner: resource ID 471, step ID 472, from bucket number 473, to bucket number 474, and to step ID 475 may be integers; resource flow quantity XRFQ may be a double floating point number. The resource ID 471 is a foreign key of resource ID 402. The step ID 472 and to step ID 475 are foreign keys of the step ID 421. The from bucket number 473 and to bucket number 474 are foreign keys of bucket number 441. Table 470 is used to map the flow of resources from a step-bucket combination to another step-bucket combination. The resource flow quantity denotes the amount of the resource that is transferred.

The flow (f=(s1,t1,s2,t2)) table 480 may be defined to include a primary key comprising from step ID (s1) 481, from bucket number (t1) 482, to bucket number (t2) 484, and to step ID (s2) 483 and a field for the flow quantity (XFQ). The fields may be further defined in the following manner: from step ID 481, from bucket number 482, to bucket number 484, and to step ID 483 may be integers; flow quantity XFQ may be a double floating point number. The from step ID 481 and to step ID 483 are foreign keys of the step ID 421. The from bucket number 482 and to bucket number 484 are foreign keys of bucket number 441. Table 480 is used to map the flow quantity from a step-bucket combination (s1, t1) to another step-bucket combination (s2, t2). The flow quantity denotes the amount of work that is transferred. In table 480, t2=t or t2=t+1.

The unindexed input/output table may be defined to include fields for minimum throughput (TLB), maximum throughput (TUB), total cost (XCost), total flow (XFlow), total staff cost (XStaff), total throughput (XT), cost per item (which is an output, not a variable), maximum cost per item (CPIUB), and minimum cost per item (CPILB). All of these field may be defined as double floating point numbers.

In this example, the primary indexes are resource ID (r) 402, bucket number (t) 441, and step ID (s) 421. Resource category ID (k) 406 is a secondary index. Constants that are input into the problem are stored in EQI in table 450; D in table 440; P in table 485; WD in table 410; AT in table 430; NUUB, NULB, SUB, FC and C in table 401; and KSUB and KSLB in table 405.

Constraints in this example are set forth below. The constraints to respect competency constrain the resource assignment so that the time a resource works on a step during a time period is equal to the work duration for the resource to do the task required by the step multiplied by the number of tasks assigned to the resource-step-bucket combination for each resource-step-bucket combination. RComp(r,s,t) may be represented as: ∀r,s,t; XRTᵣₛₜ=WD_{r,s}×XQPRᵣₛₜ. The percentage constraints may be represented as: XRFQ_{s,t,s′,t,r}=XQASB_{r,s,t}×P_{s,s′} and XRFQ_{s,t,s′,t+1,r}=XQANB_{r,s,t}×P_{s,s′}. The initial state constraints may be represented as IQSₛ=XQS_{s,0}. The quantity received constraints (QRC(s,t)) may be represented as XQR_{s,t}=Σ_{s1,t1} XFQ_{s1,t1,s,t}. The quantity processed constraints (QPC(s,t)) may be represented as XQP_{s,t}=Σᵣ XQPR_{r,s,t}, for steps requiring a resource. The respect resource availability constraints (ResAvail(r,t)) may be represented as: ∀r,t; Σₛ XRTᵣₛₜ≦XNUᵣ×AT_{r,t}. The integrity constraints may be represented as AT(r,t)≦D(t).

Resource flow consistency (RFC(s1,t1,s2,t2,r) is ensured by defining XFQ_{s1,t1,s2,t2}=Σᵣ XRFQ_{s1,t1,s2,t2,r}. This model 400 assumes WD(r,s)<<D(t). Other definitions that may be included in this model are defined as follows. Limiting the amount of each resource may be represented as NULBᵣ≦XNUᵣ≦NUUBᵣ. Limiting the size of a resource category within specified bounds may be represented as XKSₖ ε [KSLBₖ; KSUBₖ]. Setting the total amount of a given resource to the sum of the resource categories may be represented as Σ_{rεk} XNUᵣ=XKSₖ. Ensuring that each resource asssignment instance processes all but one item during a time bucket may be defined as XQANB_{r,s,t}=min(XNUᵣ, XQPR_{r,s,t}). The start of bucket quatity in XQS is defined by XQS_{s,t+1}=XQS_{s,t}+EQI_{s,t}+XQR_{s,t}−XQP_{s,t}. Earliness GP t=1 to N; max XQPTₜ=Σₛ XQP_{s,t}

Quantity consistency in table 460 is governed by: XQPR_{r,s,t}=XQASB_{r,s,t}+XQANB_{r,s,t}; XQANB_{r,s,t}≦XNUᵣ; and max Σ_{r,s,t} XQANB_{r,s,t}. An option for maximum steps per bucket may be provided in the following form: XRT_{r,s,t}≦XA_{r,s,t}×ATᵣₜ×NUUBᵣ; ∀r,t Σₛ XA_{r,s,t}≦SUBᵣ

Various objectives include minimizing total staff cost by min XStaff=Σᵣ XNUᵣ×FCᵣ; minimizing total cost by min XCost=Σ_{r,s,t} Cr×XRT_{r,s,t}; or maximizing total flow by max XFlow=Σ_{s1,t1,s2,t2} XFQ_{s1,t1,s2,t2}. The values of fields in table 490 may be constrained by CPILB×XT≦XCost≦CPIUB×XT and TLB≦max XT=Σ_{s2inSink,s1,t1,t2} XFQ_{s1,t1,s2,t2}≦TUB.

It will be understood that the methods described herein may be implemented by software running on a computer with a general purposes microprocessor.

While preferred illustrative embodiments of the invention are described above, it will be apparent to one skilled in the art that various changes and modifications may be made therein without departing from the invention. The appended claims are intended to cover all such changes and modifications that fall within the true spirit and scope of the invention.

What is claimed is:

1. A method comprising:
formulating a mixed integer program to represent a business process management model; and
obtaining a solution to the mixed integer program.

2. The method of claim 1, wherein the solution to the mixed integer program comprises a resource allocation recommendation.

3. The method of claim 1, wherein the solution to the mixed integer program comprises a resource sizing recommendation.

4. The method of claim 1, further comprising:
simulating the business process management model.

5. The method of claim 4, wherein a task dispatcher incorporates a resource assignment recommendation generated by the solving of the mixed integer program.

6. A method comprising:
determining a resource assignment for a business process comprising nodes, each node representing at least one task within the process;
generating resource assignment recommendations by applying mixed integer programming techniques to a mixed integer program, wherein the mixed integer program represents the business process; and
executing the business process, wherein at least one rule based on at least one of the resource assignment recommendations is included in the execution.

7. A mathematical model comprising:
a mixed integer program, wherein the mixed integer program represents a business process management problem.

8. The model of claim 7 further comprising:
at least one objective function.

9. The model of claim 8 wherein at least one of the objective functions is chosen from the group consisting of:
minimize one or more costs,
maximize one or more flows,
maximize output, and
minimize one or more types of resource.

10. The model of claim 7, wherein the mixed integer program comprises a plurality of equations defining relationships between two or more items chosen from a set of resources, a set of steps, and a set of time buckets.

11. The model of claim 7, wherein the mixed integer program comprises:
a plurality of decision variables, each variable representing:
a number of tasks assigned to a predetermined step—resource—time bucket combination, or
a quantity of processing performed by a predetermined step, resource, time bucket combination.

12. A data model comprising:
a representation of a business process management problem, wherein the representation comprises:
indexes for a plurality of resources, a plurality of steps, and a plurality of time buckets,
competency mappings associating resources and queue steps,
queue mappings associating steps and time buckets,
availability mappings associating resources and time buckets, and
arc mappings, each arc mapping representing work flow between two steps.

13. The model of claim 12, further comprising:
an index for a plurality of resource categories, and
resource category skill mappings associating steps and resource categories.

14. The model of claim 12, further comprising:
flow mappings, each flow mapping associating a first step and time bucket and a second step and time bucket.

15. The model of claim 12, further comprising:
resource assignment mappings, each resource mapping associating a resource, a step, and a time bucket.

16. The model of claim 12, further comprising:
resource flow mappings, each resource flow mapping associating a resource, a first step and time bucket, and a second step and time bucket.

17. A software arrangement operable on a processor, the software arrangement comprising at least one computer program which configures the processor to:
formulate a mixed integer program to represent a business process management model; and
obtain a solution to the mixed integer program.

18. The system of claim 17, wherein the solution to the mixed integer program comprises a resource allocation recommendation.

19. The system of claim 17, wherein the solution to the mixed integer program comprises a resource sizing recommendation.

20. The system of claim 17, wherein software further configures the processor to:
simulate the business process management model.

21. The system of claim 20, wherein the processor is configured to incorporate a resource assignment recommendation generated by the solving of the mixed integer program in execution of a business process.

22. A software arrangement operable on a processor, the software arrangement comprising at least one computer program which configures the processor to:
determine a resource assignment for a business process comprising nodes, each node representing at least one event within the process;
generate resource assignment recommendations by applying mixed integer programming techniques to a mixed integer program, wherein the mixed integer program represents the business process; and
execute the business process, wherein software configures the process to included at least one rule based on at least one of the resource assignment recommendations in the execution.
